(19) United States
(12) Patent Application Publication
(10) Pub. No.: US 2025/0319505 A1
(43) Pub. Date: Oct. 16, 2025

(54) Waste Processing Plant and Method for Waste Processing

(71) Applicant: Quantum Cycle LLC, Lewes, DE (US)

(72) Inventor: Leonardo Ezequiel GOMEZ, Luján (AR)

(21) Appl. No.: 19/175,708

(22) Filed: Apr. 10, 2025

(30) Foreign Application Priority Data
Apr. 11, 2024 (AR) 2024 0100910

(51) Int. Cl. B09B 3/35; B02C 21/00; B02C 23/18; B09B 3/40; B09B 101/25

(52) U.S. Cl. CPC B09B 3/35; B02C 21/00; B02C 23/18; B09B 3/40; B09B 2101/25

(57) ABSTRACT

A waste processing plant and method for processing waste, wherein a reduced processed final waste is obtained in powder form that can be reused for other purposes, in addition to allowing the evacuation and storage of gases and/or vapors that are produced during processing so that they can be stored and used for other purposes and thus protect the environment.

### FIELD OF THE INVENTION

The present invention relates to a waste processing plant that is built and constructed in such a manner as to significantly reduce, through a waste processing method, the incoming waste and obtain a reduced processed final waste in powder form that can be reused for other purposes, the gases and/or vapors generated during processing also being treated and stored in respective storage tanks for later use.

### DESCRIPTION OF THE PRIOR ART

As is known in the technical field, waste generated is collected daily from homes through the residential waste collection service and then transported to a facility or plant where it will be stored temporarily until it is processed.

In practice, waste processing involves a series of steps designed to efficiently handle waste, maximizing resource recovery and minimizing environmental impact. Among the steps within the plant or facility are reception and unloading, with waste arriving at the processing plant via collection vehicles. Here, unloading takes place, and the quantity and type of waste received is recorded. Then, an initial waste separation is performed to eliminate unwanted and hazardous materials, such as household appliances, batteries and chemicals.

Once unwanted materials have been separated, automated sorting and separation is carried out using specialized equipment and machinery, such as conveyor belts and magnetic separators, to sort and separate recyclable materials (plastic, glass, metals) from non-recyclable waste. Also, recyclable materials are collected and sent to specific facilities for processing and recycling. This may include shredding, melting, or any other method according to the material. Moreover, organic waste, such as food scraps and biodegradable materials, can be composted to produce compost that can be used as fertilizer.

However, while there are many solid waste treatment systems, the main and most widely used are incineration, controlled landfill, pyrolysis, and biomethanation.

Incineration consists, as its name suggests, of incinerating waste, that is, thermally destroying waste until it is transformed into combustion gases or products such as ash. With specialized plants, large amounts of energy can be obtained from incinerated waste. On the other hand, there is the solid waste treatment system through controlled disposal in landfills. To prevent waste from contaminating land or nearby waters, proper landfill management and design are necessary. Landfills can be underground or located on a surface. Abandoned quarries or mines are commonly used for this purpose, but in any case, these sites must be studied and controlled to minimize the environmental impact of waste.

Another of the most widely used solid waste treatment systems is pyrolysis. This is a system wherein waste undergoes thermal treatment in a sealed container under high pressure. This urban solid waste treatment system stands out as it is more effective than incineration, as pyrolysis produces much greater amounts of energy. The thermal degradation of waste occurs with a very limited amount of oxygen, resulting in gases, liquids, and inert materials.

On the other hand, a type of solid waste crushing machine may be that disclosed in the Application Published as AR064857 A1 by BREST, which teaches a machine suitable for receiving solid materials in bulk and crushing them until obtaining a fine granulometry by mechanical action through blades. This equipment comprises a vertical treatment housing consisting of an upper loading opening connected to an intermediate crushing chamber, which is traversed by at least one horizontal shaft carrying a plurality of cutting blades, followed by a lower lateral discharge section; said shaft being mounted on ball-bearings arranged in respective opposite and parallel side walls, which extends to one side to engage the output shaft of an electric motor mounted on a support frame adjacent to said treatment housing. The upper loading comprises a horizontal opening corresponding to its upper base, combined with a lateral loading window defined in a side wall at the upper portion. Inside the crushing chamber, there is an inclined plate that directs the material to fall toward the crushing blades. Below the crushing chamber, there is a mesh plate inclined toward the lower discharge opening, under which a horizontal liquid collection tray is arranged.

Yet another type of machine may be that disclosed in the Application Published as AR097276 A1 by BAIOCCO, which teaches a frustoconical hopper having, near its open major base, where waste is introduced, a water inlet tangential spout which minor base extends into a vertical conduit through which the waste falls to a lower housing which enclosing surface forms a cone with a gradual decrease in its section downwardly, having a plurality of vertical projections acting as radial blades which depth decreases towards their lower ends due to the aforementioned conical nature of the enclosing face, while its leading edges define a cylindrical space wherein a rotor formed by radial blades that project, rotates with a clearance adjusted to the size of the crushed particles, between an upper support in a circular crown and a lower circular support, with an obliquity that determines the advance of its upper part in the direction of rotation, emerging from the aforementioned lower support a coupling tube, isolated of wet waste, connected to a vertical-axis electric motor arranged below a collector with drainage discharge on an inclined plane.

On the other hand, Chinese Patent Application CN101890390 A discloses a waste fine crusher. The fine crusher comprises a feed cylinder, wherein the feed cylinder is provided with a feed port; a rotatable propeller rod located inside the feed cylinder is connected to a pressurizing motor and provided with helical blades extending axially; the outer diameter of the helical blades matches the inner diameter of the feed cylinder; the outlet end of the feed cylinder is connected to a pressurizing section; the sectional area of the inner space of the pressurizing section gradually reduces along the outlet direction; and a rotating cutter is located at the outlet of the pressurizing section, and connected to a cutting motor. The waste fine crusher can effectively cut and crush plastics and other organic objects once organic waste is first compacted, and has a good crushing effect.

As to processes, Utility Model CN 217450333 U describes a device for recovering construction waste and use of broken discarded objects, comprising a body, the bottom of the device is provided with a feed inlet, the bottom of the device is provided with a discharge gate, a cavity in the device, and two crushing rollers in the cavity, one of the crushing roller fixedly connected with a shaft, the device fixedly connected to a driving motor passes through one end of the shaft, the other end of the shaft rotates with the inner wall of the cavity to be connected, the shaft is near the first pulley of the driving motor with one end fixedly connected. The utility model describes a set-up air jet mechanism, which is convenient for inhaling the dust produced when handling it in the box with the internal crushing process of the device, preventing the dust from entering the air and causing environmental pollution and damaging the respiratory tract of humans.

Yet another type of process is disclosed in Utility Model CN212664484 U, which describes a device for treating and recovering waste materials for cardboard processing and relates to the field of cardboard processing technology. The utility model describes a crushing box, a compression box, a collection box, a crushing chamber and a drainage filling, one side fixedly connected with the box crushing motor, the outlet fixedly connected with the motor driving pivot, the first crushing blade fixedly connected to the driving pivot, the crushing box oscillating joint of the rear portion of the driving pivot has a driven spindle, the crushing blade fixedly connected to the second on the driven spindle, the crushing chamber is installed at the top to break the box, and is provided with four side by side to break the chamber, the lower fixed connection to break the box is in the compression box, the fixed connection with drainage fills the compression box to break the box below, the collection box is placed in the compression box of the holding plate below.

In short, solid waste treatment is not only important for controlling the environmental impact of the waste inevitably generated every day, but it is also a way to reuse discarded materials and obtain benefits such as energy, fuel, or fertilizers from materials that are no longer useful and would otherwise end up polluting the land, air, and water. For these reasons, it is of utmost importance that waste processing facilities constantly seek new technologies and practices to improve efficiency, reduce waste, and minimize environmental impact.

In view of the current state of the art in waste treatment, it would be highly desirable to have a waste treatment facility, plant, or installation that would reduce the amount of waste received and allow for the reuse of byproducts and final products.

### BRIEF DESCRIPTION OF THE INVENTION

It is therefore an object of the present invention to provide a new waste processing plant which allows to significantly reduce the amount of final processed product output in a more environmentally friendly manner.

It is also another object of the present invention to provide a waste processing plant designed in such a way as to obtain a final reduced waste processed in powder form that can be reused for other purposes. It is still another object of the present invention to provide a waste processing plant that simultaneously with processing of waste, also carries out the evacuation and treatment of the gases and/or vapors generated within decomposers.

It is yet another object of the present invention to provide a waste processing plant that provides at least two stages of waste processing so as to guarantee a reusable final product.

It is still another object of the present invention to provide a waste processing plant designed and constructed in a much simpler manner compared to current industrial plants.

It is also another object of the present invention to provide a waste processing plant characterized by comprising: at least one first decomposer in the form of a chamber which has a first decomposer feed inlet, at least a first decomposer crushing means and at least one first decomposer outlet port; at least one second decomposer adjacent to said first decomposer, the interior of which is communicated with the first decomposer through said first decomposer outlet port, said second decomposer comprises a second decomposer crushing means, at least a second decomposer heating assembly and at least a second decomposer discharge gate; at least a processed material receiving module arranged immediately below, and in communication with, said at least one second decomposer discharge gate; at least a processed material storage hopper operatively connected to said processed material receiving module; and at least corresponding gas collection arrangements located on the upper portion of said first decomposer and second decomposer, operatively communicated with respective gas storage tanks.

It is yet another object of the present invention to provide a method for processing waste using the waste processing plant and comprising the steps of:
a) discharging the waste into a pit below ground level and outside the plant;
b) operating the first feed conveyor belt so as to transport the waste from the pit to the first decomposer feed inlet;
c) operating the crushing means of the first decomposer so that the waste falling from the first decomposer feed inlet be impacted, cut and crushed by said first decomposer high-impact upper breaking assembly, first decomposer intermediate tangential blade assembly, and first decomposer lower sweeper assembly, until obtaining a partially processed residue that is dragged towards said second decomposer;
d) simultaneously with step c), operating the first decomposer waste gas turbine in order to extract the gases and/or vapors from the interior of the first decomposer and evacuate the same to the triangular section collector;
e) corroborating the state of the partially processed waste through a camera provided inside said first decomposer;
f) operating the first decomposer outlet gate so that the first decomposer lower sweeper assembly drags the partially processed residue into the second decomposer through the first decomposer outlet port;
g) operating the second decomposer crushing means so that the partial processed residue entering the second decomposer through the first decomposer outlet gate be further processed through said second decomposer high-impact upper breaking assembly, second decomposer intermediate first impact blade assembly, second decomposer tangential lower blade assembly, and second decomposer lower sweeper assembly, until obtaining a reduced processed final residue in powder form;
h) simultaneously with step g), operating the second decomposer heating assembly to a temperature set according to the volume of waste to be processed;
i) simultaneously with step g), operating the second decomposer waste gas turbine in order to extract the gases and/or vapors from the interior of the second decomposer and evacuate them to the triangular section collector;
j) operating the second decomposer discharge gate so that the final processed reduced residue be dragged to said processed material receiving module; and
k) operating the processed material suction pump so that the reduced processed final waste be transported for storage in said processed material storage hopper.

It is another object of the present invention to provide a waste decomposer comprising, at least, a crushing means, wherein said crushing means comprises a high-impact upper breaking assembly, an intermediate tangential blade assembly, and a lower sweeper assembly, wherein:
said high-impact upper breaking assembly comprises a plurality of curved arms radially mounted at one end of a driving shaft of the crushing means;
said intermediate tangential blade assembly comprises a plurality of blades tangentially located on an upper surface of a support disc mounted on said driving shaft of the crushing means;
said first decomposer lower sweeper assembly comprises a plurality of sweepers radially located on a lower surface of said support disc mounted on said driving shaft of the crushing means;
said driving shaft of the first decomposer crushing means being actuated by means of a set of pulleys, belts and gearmotors.

In one embodiment the waste decomposer of the present invention further comprises at least a heating assembly; wherein said heating assembly comprises a plurality of resistors arranged on the outside of said decomposer, said resistors being connected to respective thermocouples.

In one embodiment, the waste decomposer of the present invention further comprises at least a water injection arrangement in order to inject cold water into the interior and control its temperature.

In one embodiment the waste decomposer of the present invention further comprises at least a driven blade arrangement located on the upper portion of said decomposer.

In one embodiment the waste decomposer of the present invention further comprises gas collection arrangements located on the upper portion of said decomposer; wherein said gas collection arrangements comprise:
at least a waste gas turbine operated by a corresponding turbine engine, and
a pair of gas discharge pipes having an upper end connected to said waste gas turbine and a lower end connected to means for treating said gases.

In one embodiment said gas treatment means comprises a triangular section collector provided with a triangular collector turbine driven by means of a turbine gearmotor and a conditioning chamber connected to said triangular section collector comprising a coating with an arrangement of electrical resistors, in turn said conditioning chamber being operatively connected to gas storage tanks.

### BRIEF DESCRIPTION OF THE DRAWINGS

For greater clarity and understanding of the object of the present invention, the invention has been illustrated in several figures, represented in one of the preferred embodiments, all by way of example, wherein:

FIG. 1 shows a perspective view of the waste processing plant according to this invention;

FIG. 2 shows a partial view of the plant of the invention;

FIG. 3 shows another partial view of the plant of the invention;

FIG. 4 shows a perspective and enlarged view of a first crushing means of a first decomposer according to this invention;

FIG. 5 shows an enlarged view of a lower portion of the first decomposer according to this invention;

FIG. 6 shows a perspective view of a second decomposer according to this invention;

FIG. 7 shows a perspective and partially cut-away view of the second decomposer according to the invention;

FIG. 8 shows an enlarged view of a crushing means of the second decomposer according to this invention;

FIG. 9 shows a partial enlarged view of a processed material receiving module adjacent to the second decomposer according to this invention;

FIG. 10 shows an enlarged view of an arrangement of resistors that externally cover said second decomposer;

FIG. 11 shows a partially cut-away enlarged view of a portion of the plant according to this invention, wherein a gas collection arrangement can be observed in conjunction with respective gas storage tanks;

FIG. 12 shows an enlarged view of the driving means of respective driving shafts of the crushing means of both the first decomposer and the second decomposer;

FIG. 13 shows an enlarged view of a gas collection arrangement located on the upper portion of one of the decomposers according to this invention; and

FIG. 14 shows a partial view of gas storage tanks according to this invention.

### DETAILED DESCRIPTION OF THE INVENTION

Referring now to the figures, it can be seen that the invention consists of a new waste processing plant which allows obtaining a reduced processed final waste in powder form that can be reused for other purposes, in addition to allowing the evacuation and storage of gases and/or vapors that are produced during processing so that they can be stored and used for other purposes and thus protect the environment.

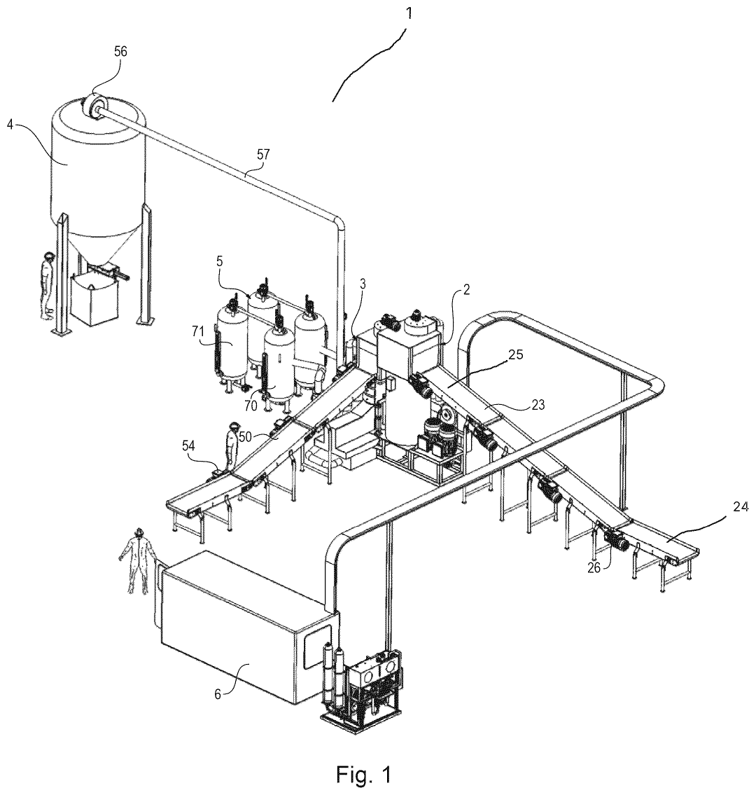

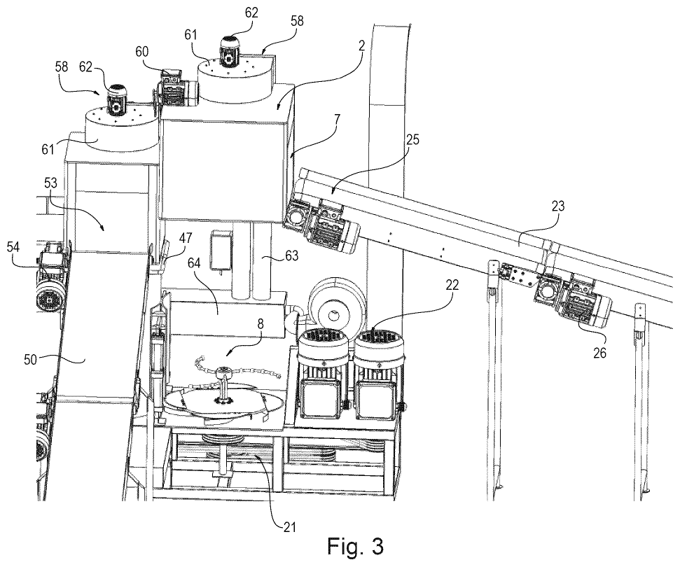

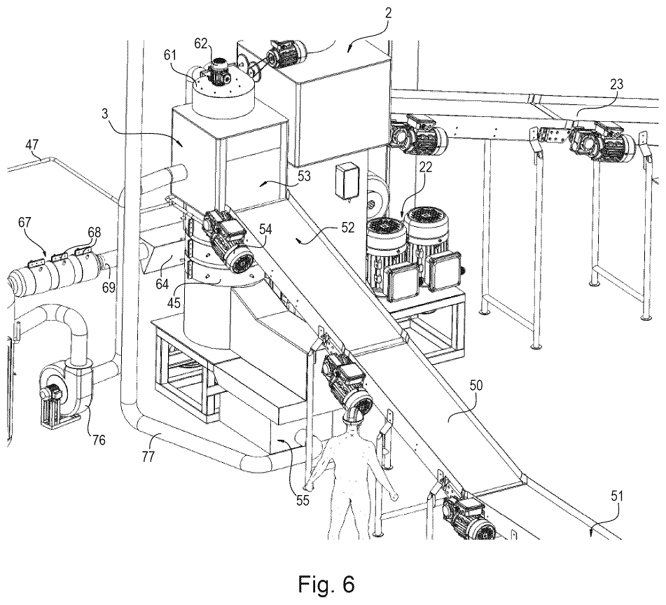

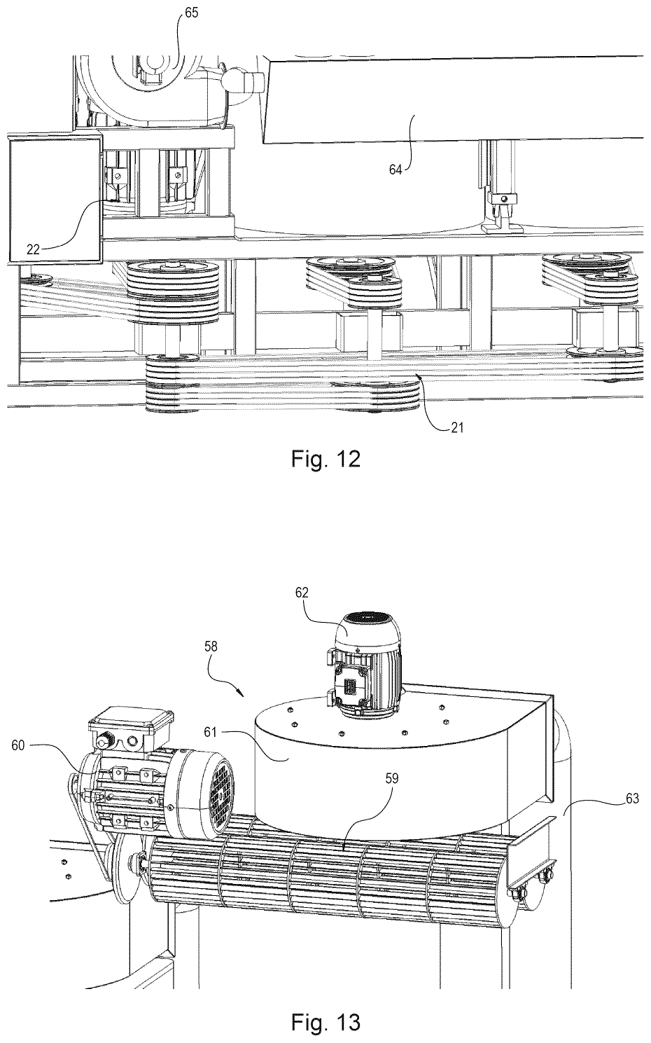

Thus, and according to FIGS. 1 to 14, the waste processing plant of this invention is indicated by general reference 1 and comprises generally at least a first decomposer 2, at least a second decomposer 3, at least a processed material storage hopper 4, at least an arrangement of gas storage tanks 5 and an operations center 6 as best illustrated in FIG. 1.

Wherein, said first decomposer 2 comprises a chamber form (see FIG. 3) on the upper side of which there is a first decomposer feed inlet 7, whereas at the lower portion there is at least a first decomposer crushing means 8 and at least one first decomposer outlet gate 9. Said first decomposer crushing means 8 will allow mechanical decomposition of the waste in order to reduce it until it is in a powder state.

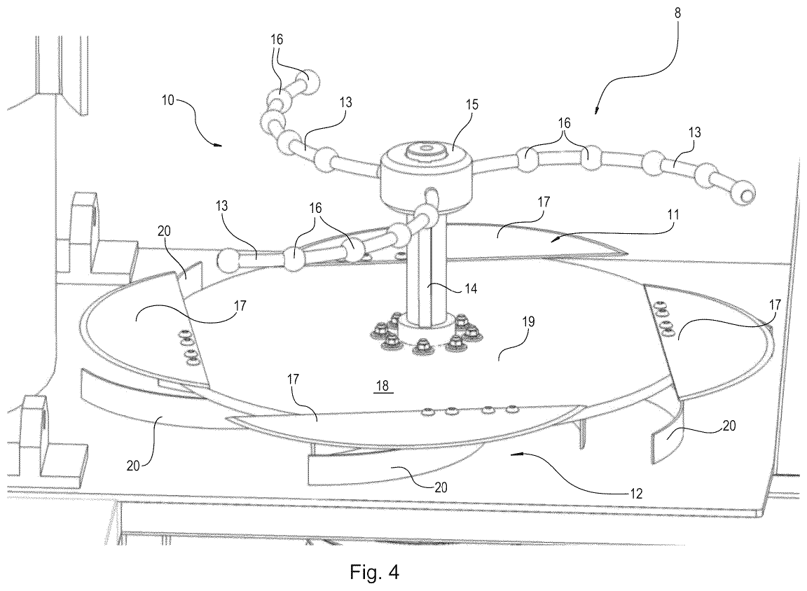

To that end, FIG. 4, said first decomposer crushing means 8 comprises a first decomposer high-impact upper breaking assembly 10, a first decomposer intermediate tangential blade assembly 11, and a first decomposer lower sweeper assembly 12, wherein said first decomposer high-impact upper breaking assembly 10 comprises a plurality of curved arms 13 radially mounted at one end of a driving shaft of the first decomposer crushing means 14 through a curved arm base 15. It is noted that, to facilitate decomposition of waste, said curved arms 13 comprise a plurality of 16 spheres that generate a high-speed impact on the waste in order to molecularly decompose each component of the waste.

In addition, said first decomposer intermediate tangential blade assembly 11 comprises a plurality of blades 17 tangentially arranged on an upper surface 18 of a support disc 19 mounted on said driving shaft of the first decomposer crushing means 14. In turn, said first decomposer lower sweeper assembly 12 comprises a plurality of sweepers 20 radially arranged on a lower surface of said support disc 19 mounted on said driving shaft of the first decomposer crushing means 14. It is noted that, said driving shaft of the first decomposer crushing means 14 is actuated by means of a set of pulleys, belts 21 and gearmotors 22.

On the other hand, in order to feed the first decomposer 2, FIGS. 1 to 3, a first feed conveyor belt 23 is provided, having a lower belt end 24 that takes the waste stored in a pit to convey it to an upper belt end 25 which is in communication with said first decomposer feed inlet 7, said feed conveyor belt 23 being driven by means of respective gear motors 26. The speed of the first conveyor belt 23, like its dimensions, varies according to the amount of waste to be processed.

Thus, waste enters through the first decomposer feed inlet 7 and contacts the first decomposer crushing means. Upon rotation, decomposes the waste by mechanical action. In addition to reducing the volume of waste, this helps increase the temperature, promoting the evaporation of liquids. Also, the high-speed impact allows for the molecular decomposition of each component of waste. All this is due to the fact that the waste experiences thermal changes (hot/cold) due to the movement of the blade assemblies, the impact of waste on it, the friction of waste with the blade assemblies and the inner walls and airflow generated by the rotation of decomposing waste. It is noted that, for example, but not limiting the invention, the rotation of the driving shaft of the second decomposer crushing means 14 may range from 0 to 6000 rpm, without limiting the invention.

Thus, the waste enters the first decomposer without the need to be segregated, that is, within the first decomposer everything is processed together. It is worth mentioning that the components typically found in waste to be processed are: aluminum, steel, non-ferrous metals, glass, textile components, paper, cardboard, various plastics, organic waste, forestry waste, debris, electronic and electrical components, medications, and more.

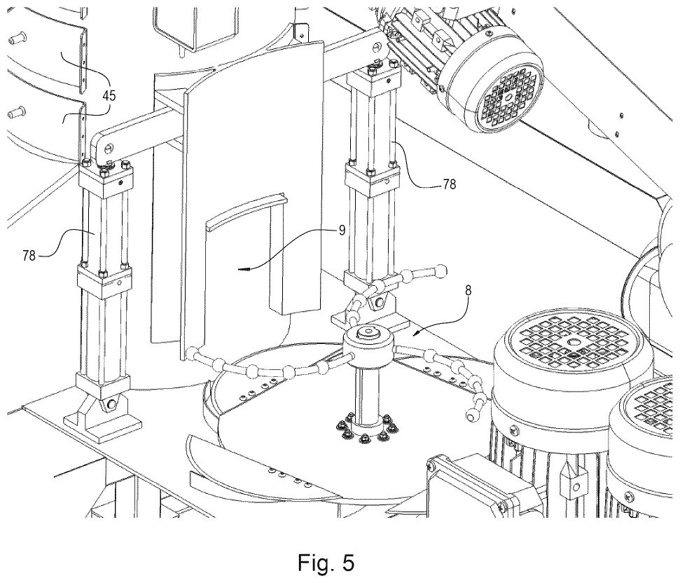

Now referring to said at least one second decomposer 3, it is arranged adjacent to said first decomposer 2 and is internally communicated with said first decomposer 2 through said first decomposer outlet gate 9 as best illustrated in FIG. 5, said second decomposer 3 comprises a second decomposer crushing means 27, at least a second decomposer heating assembly 28 and at least a second decomposer discharge gate 29.

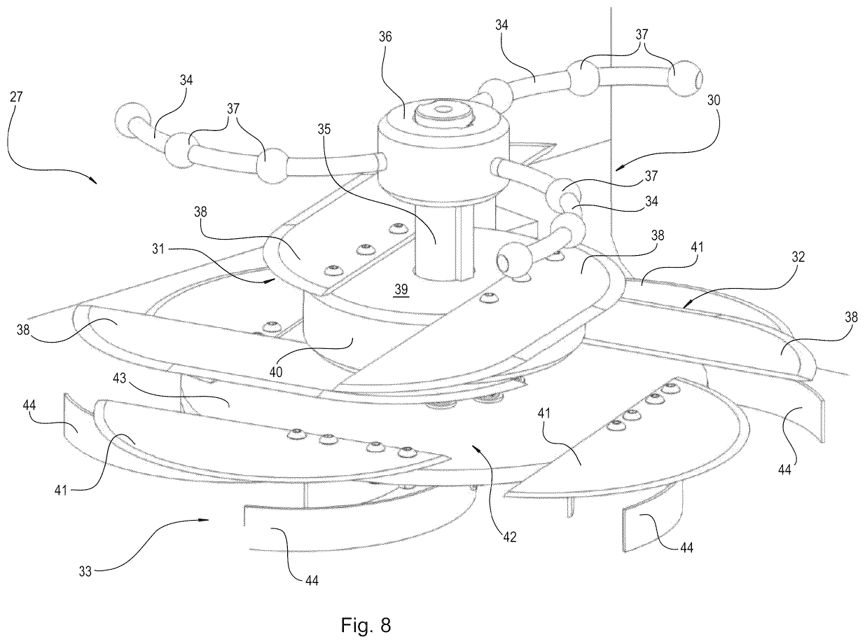

According to the invention, said second decomposer 3 comprises a chamber form on the lower part of which is arranged said second decomposer crushing means 27 communicated with said first decomposer outlet gate 9, said second decomposer crushing means 27 has a second decomposer high-impact upper breaking assembly 30, a second decomposer intermediate first impact blade assembly 31, a second decomposer tangential lower blade assembly 32, and a second decomposer lower sweeper assembly 33, as best illustrated in FIG. 8.

Wherein, said second decomposer high-impact upper breaking assembly 30 comprises a plurality of curved arms 34 radially mounted at one end of a driving shaft of the second decomposer crushing means 35 through a curved arm base 36. It is noted that, to facilitate decomposition of waste, said curved arms 34 comprise a plurality of spheres 37 that generate a high-speed impact on the waste in order to molecularly decompose each component of the waste.

In addition, said second decomposer intermediate first impact blade assembly 31 comprises blade assembly 38 radially mounted on an upper surface 39 and on a lower surface of an intermediate assembly support 40 mounted on said driving shaft of the second decomposer crushing means 35. In turn, said second decomposer tangential lower blade assembly 32 comprises a plurality of blades 41 tangentially arranged on an upper surface 42 of a support disc 43 mounted on said driving shaft of the second decomposer crushing means 35. In turn, said second decomposer lower sweeper assembly 33 comprises a plurality of sweepers 44 radially arranged on a lower surface of said support disc 43 mounted on said driving shaft of the crushing means of the second decomposer 35. It is noted that, said driving shaft of the crushing means of the second decomposer 35 can also be actuated by means of said set of pulleys, belts 21 and gearmotors 22.

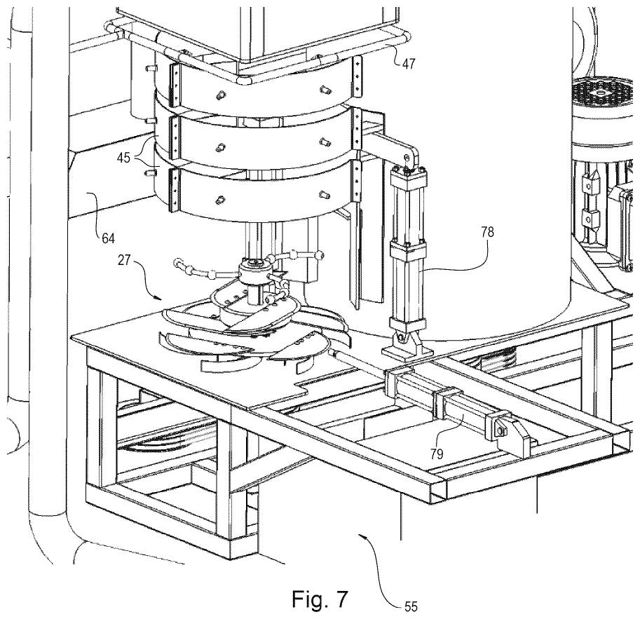

In turn, and to promote the evaporation of liquids and generation of vapors, FIGS. 7 and 10, the second decomposer 3 features said at least one second decomposer heating assembly 28 that comprises a plurality of resistors 45 arranged on the outside of said second decomposer 3 and together with respective thermocouples that detect the internal temperature. This allows the liquids that were not evaporated in the first decomposer 2 to evaporate. It should be understood that the greater the amount of liquid to be evaporated, the higher the temperature will be required.

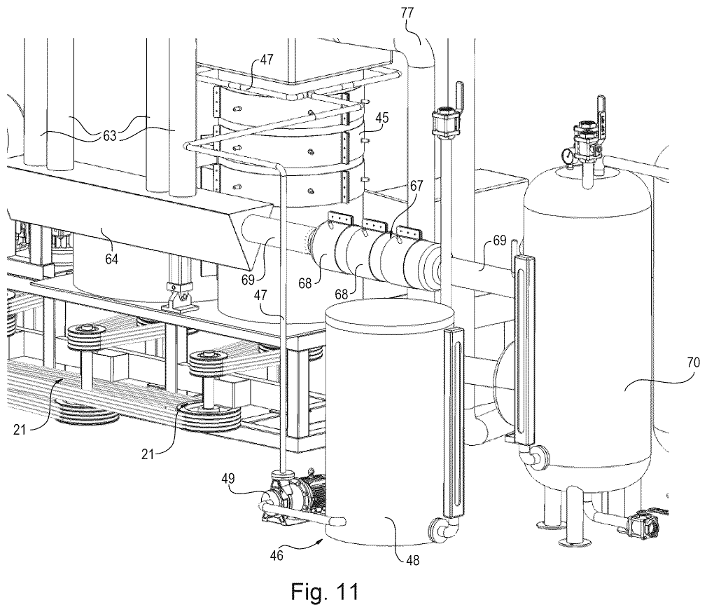

In addition, the second decomposer 3 is provided with at least one thermometer to detect the internal temperature. In the event of exceeding a predetermined temperature threshold, the second decomposer 3 is provided with at least a water injection arrangement 46 that comprises at least one pipe 47 which extends until a section of the same is arranged around said second decomposer 3 in order to inject cold water inside the same, said pipe 47 being connected to a cold-water storage tank 48 through an injection pump 49, as best illustrated in FIG. 11. The water injection arrangement 46 allows to control temperature inside the second decomposer 3 so as to avoid exceeding the ideal temperature, this is because at higher temperatures, the solid material decomposes but not completely, and its weight is so low that it can then be aspirated by the gas collection arrangement that will be described below. For example, but not limiting the invention, the operating temperature at the second decomposer 3 may range from 20° C. to 500° C., whereas rotation of the driving shaft of the second decomposer crushing means 35 may range from 0 to 6000 rpm, without limiting the invention.

If necessary due to an increase in the amount of waste to be processed, the second decomposer 3 is provided with at least a second feed conveyor belt 50 which has a lower end 51 that takes the waste from the pit and conveys it to an upper end 52 that is in communication with the second decomposer feed inlet 53, said second feed conveyor belt 50 is driven by gear motors 54.

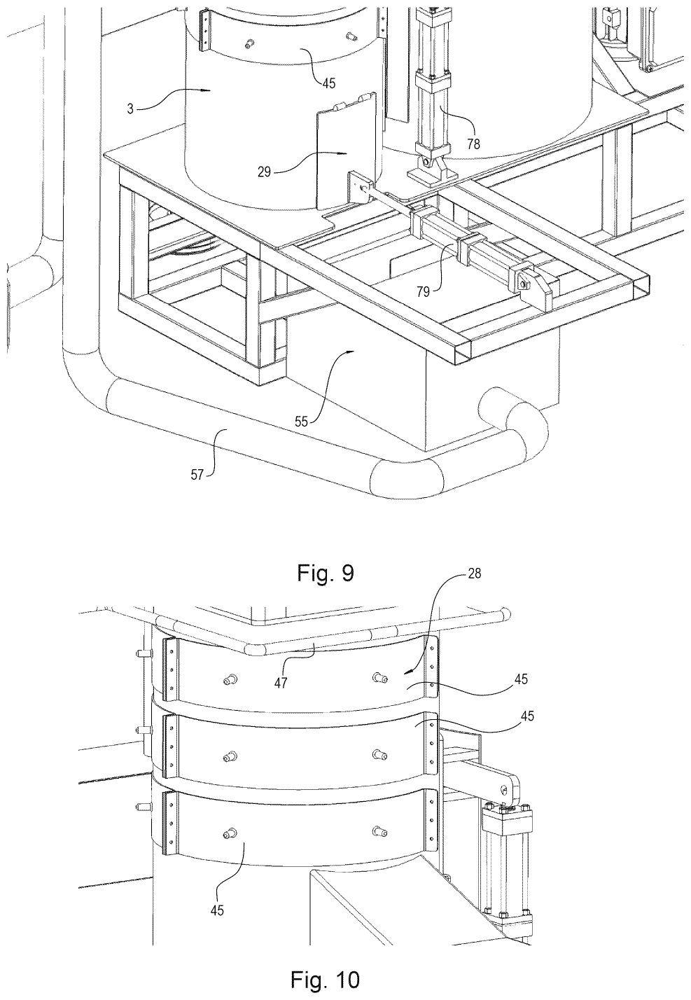

In this way, the waste that enters the first decomposer 2 is mechanically processed in a first stage and then goes through the second decomposer 3 for further processing, until obtaining a reduced processed final residue in powder form, which is discharged in at least one processed material receiving module 55 arranged immediately below, and in communication with, said at least one second decomposer discharge gate 29, as best illustrated in FIGS. 7 and 9.

Finally, the reduced processed final waste in powder form is transferred to said processed material storage hopper 4 by a processed material suction pump 56 arranged at the upper portion of the same, said processed material suction pump 56 is connected to said processed material receiving module 55 through a respective pipe 57. It is noted that, said processed material storage hopper 4 has a lower hopper discharge gate to discharge the reduced processed final waste in powder form for storage in bags or similar.

According to this invention, during the processing of waste inside the first 2 and second 3 decomposers, gases and/or vapors are produced which are evacuated and treated for subsequent storage. To this end, the invention provides at least corresponding gas collection arrangements 58 located on the upper portion of said first decomposer 2 and second decomposer 3, operatively communicated with said gas storage tanks 5. Prior to contacting said gas collection arrangements 58, gases and/or vapors go through a driven blade arrangement 59 arranged at the upper portion of both said first decomposer 2 and said second decomposer 3, as best illustrated in FIG. 13. Although in the present invention only said arrangement of driven blades 59 has been illustrated in said first decomposer 2, this does not imply that the invention is limited to it since the second decomposer 3 can also be provided with said arrangement of driven blades 59 without any inconvenience. Said driven blades 59 are actuated by means of respective blade gearmotors 60 and promote decomposition of the macromolecules that are suspended between the gases and vapors.

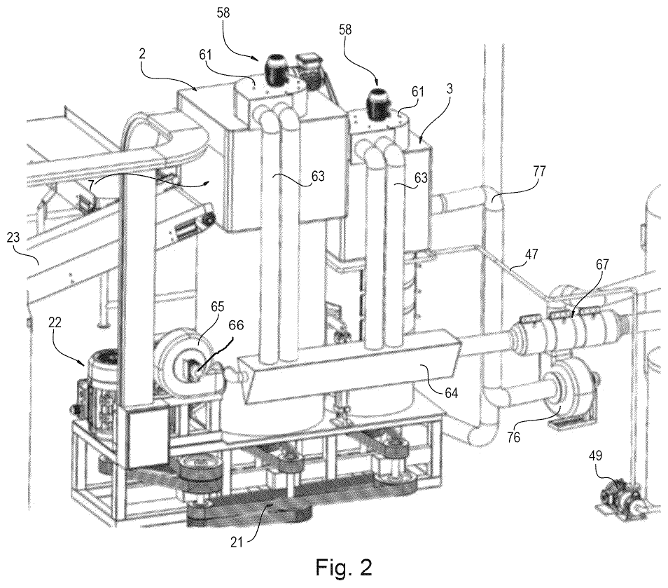

Once past said arrangement of driven blades 59, gases are absorbed by said gas collection arrangements 58 each of which comprises at least a waste gas turbine 61 operated by a corresponding turbine engine 62, and a pair of gas discharge pipes 63 having an upper end connected to said waste gas turbine 61 and a lower end connected to a triangular section collector 64 equipped with a triangular collector turbine 65 actuated by a turbine gearmotor 66, as best illustrated in FIG. 2. The triangular section collector 64 has a triangular shape because the high-speed impact of gases and vapors favors the release of liquids suspended within them. From this point is when the distillation process begins, that is, the separation of liquids and gases derived from oil.

Continuing with the route of gases and/or vapors, FIGS. 2, 7, 11 and 14, a conditioning chamber 67 is connected to said triangular section collector 64 comprising a coating with an arrangement of electrical resistors 68, in turn said conditioning chamber being operatively connected to said gas storage tanks 5 through respective gas transport pipes 69. The conditioning chamber 67 consists of a pipe of a larger diameter than the gas transport pipe 69, covered with said arrangement of electrical resistors 68 so as to heat the gases in case it is to be activated for later use. By way of example, but not limiting the invention, the operating temperature within the conditioning chamber 67 may be in the range between 60° C. and 80° C.

Once the gases and/or vapors go through the conditioning chamber 67, they are stored in said gas storage tanks 5. There, a first gas storage tank 70 is at room temperature to promote thermal shock during bubbling in order to obtain better evaporation of gases. Along with said first gas storage tanks 70, respective backup gas storage tanks 71 are provided, which can be heated by means of resistors (not shown) if activation of gas is required. By way of example, but not limiting the invention, the operating temperature within the gas storage tanks 70 and 71 is in the range of 80° C. to 100° C.

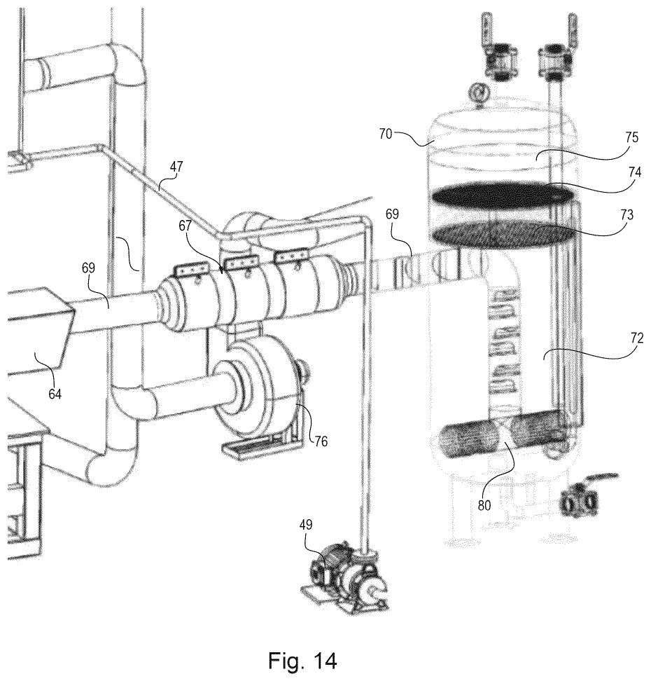

According to FIG. 14, each of said gas storage tanks 70 and 71 internally comprises at least one lower perforated tee 80 connected to said gas transport pipe 69 and submerged in a volume of water 72; at least a first filtering layer 73 arranged immediately above the water volume 72 and comprising a perforated sheet metal chamber provided with expanded polystyrene spheres immersed in lithium oil; at least a second filtering layer 74 arranged upstream of said first filtering layer 73, comprising solid carbon; and at least a third filtering layer 75 arranged upstream of said second filtering layer 74, comprising lithium oil together with polypropylene beads. The layers of lithium oil prevent grease, paraffin, and other liquid impurities from remaining in the first layer and from escaping with the vapor. In turn, the volume of water lowers the temperature of the incoming gases, causing both condensable gases and vapors to become liquid and descend with the liquids, dragging the gases to the bottom of each gas storage tank. In addition, all 5 gas storage tanks have an upper discharge valve for gas extraction and a lower valve for liquid extraction.

In the event of having to deal with a flow of waste greater than that programmed, and consequently, having to evacuate a greater quantity of gases and/or vapors, a secondary gas collection arrangement is provided, which comprises a secondary waste gas turbine 76 that can be connected to at least said first gas storage tank 70 and to the upper side portion of at least the second decomposer 3 through a secondary gas transport pipe 77.

It is noted that, the first decomposer outlet gate 9 and the second decomposer discharge gate 29 are actuated by means of pneumatic drive cylinders 78 and 79, respectively. The operation of the parts comprising the plant of the invention, that is gearmotors, resistors, pneumatic cylinders, etc., is controlled by electronic arrangements well known in the art, and for these reasons, will not be described further. Operations and controls are commanded from the operations center 6.

In relation to the waste processing method of the invention that allows to significantly reduce the amount of waste and at the same time be able to obtain a reduced processed final waste in powder form that can be reused, the method comprises the steps of:
a) discharging the waste into a pit below ground level and outside the plant;
b) operating the first feed conveyor belt so as to transport the waste from the pit to the first decomposer feed inlet;
c) operating the crushing means of the first decomposer so that the waste falling from the first decomposer feed inlet be impacted, cut and crushed by said first decomposer high-impact upper breaking assembly, first decomposer intermediate tangential blade assembly, and first decomposer lower sweeper assembly, until obtaining a partially processed residue that is dragged towards said second decomposer;
d) simultaneously with step c), operating the first decomposer waste gas turbine in order to extract the gases and/or vapors from the interior of the first decomposer and evacuate the same to the triangular section collector;
e) corroborating the state of the partially processed waste through a camera provided inside said first decomposer;
f) operating the first decomposer outlet gate so that the first decomposer lower sweeper assembly drags the partially processed residue into the second decomposer through the first decomposer outlet port;
g) operating the second decomposer crushing means so that the partial processed residue entering the second decomposer through the first decomposer outlet gate be further processed through said second decomposer high-impact upper breaking assembly, second decomposer intermediate first impact blade assembly, second decomposer tangential lower blade assembly, and second decomposer lower sweeper assembly, until obtaining a reduced processed final residue in powder form;
h) simultaneously with step g), operating the second decomposer heating assembly to a temperature set according to the volume of waste to be processed;
i) simultaneously with step g), operating the second decomposer waste gas turbine in order to extract the gases and/or vapors from the interior of the second decomposer and evacuate them to the triangular section collector;
j) operating the second decomposer discharge gate so that the final processed reduced residue be dragged to said processed material receiving module; and
k) operating the processed material suction pump so that the reduced processed final waste be transported for storage in said processed material storage hopper.

In case of increased demand for waste to be processed, simultaneously with step b), it is provided the step of operating the second feed conveyor belt of the second decomposer 50 in order to convey the waste from the pit to the second decomposer feed inlet 53. In this case, the secondary gas collection arrangement described above is also activated. In addition, to control temperature at the second decomposer 3, simultaneously with step h) water is injected through the water injection arrangement 46 according to a temperature threshold detected by the thermocouples.

The method of the invention also comprises the step of operating the triangular collector turbine 65 so that the gases coming from the first and second decomposer 2-3 pass forcibly through said triangular section collector 64 in order to produce the release of the liquids in suspension from the gases and/or vapors. After going through the triangular section collector 64, the gases cross the conditioning chamber 67 in order to raise the temperature of gases and/or vapors circulating and coming from the triangular section collector 64. Finally, gases and/or vapors are stored in the gas storage tanks 5.

In this way, the waste processing plant of this invention is built and constructed, allowing by means of the above method to obtain reduced processed final waste in powder form and simultaneously stored and treated gas, both of which can be reused for other purposes without any inconvenience.

What is claimed is:

1. A waste processing plant comprising:
at least one first decomposer in the form of a chamber which has a first decomposer feed inlet, at least a first decomposer crushing means and at least one first decomposer outlet port;
at least one second decomposer adjacent to said first decomposer, the interior of which is communicated with the first decomposer through said first decomposer outlet port, said second decomposer comprises a second decomposer crushing means, at least a second decomposer heating assembly and at least a second decomposer discharge gate;
at least one processed material receiving module arranged immediately below, and in communication with, said at least one second decomposer discharge gate;
at least a processed material storage hopper operatively connected to said processed material receiving module; and
at least corresponding gas collection arrangements located on the upper portion of said first decomposer and second decomposer, operatively communicated with respective gas storage tanks.

2. A waste processing plant according to claim 1, further comprising a first feed conveyor belt having a lower belt end and an upper belt end in communication with said first decomposer feed inlet, said feed conveyor belt being driven by means of respective gear motors.

3. A waste processing plant according to claim 1, wherein said first decomposer crushing means comprises a first decomposer high-impact upper breaking assembly, a first decomposer intermediate tangential blade assembly, and a first decomposer lower sweeper assembly, wherein:
said first decomposer high-impact upper breaking assembly comprises a plurality of curved arms radially mounted at one end of a driving shaft first decomposer crushing means;
said first decomposer intermediate tangential blade assembly comprises a plurality of blades tangentially located on an upper surface of a support disc mounted on said driving shaft of the first decomposer crushing means;
said first decomposer lower sweeper assembly comprises a plurality of sweepers radially located on a lower surface of said support disc mounted on said driving shaft of the first decomposer crushing means;
said driving shaft of the first decomposer crushing means being actuated by means of a set of pulleys, belts and gearmotors.

4. A waste processing plant according to claim 1, wherein said second decomposer comprises a chamber form on the lower part of which is arranged said second decomposer crushing means in communication with said first decomposer outlet port, said second decomposer crushing means has a second decomposer high-impact upper breaking assembly, a second decomposer intermediate first impact blade assembly, a second decomposer tangential lower blade assembly, and a second decomposer lower sweeper assembly, wherein:
said second decomposer high-impact upper breaking assembly comprises a plurality of curved arms radially mounted at one end of a driving shaft of the second decomposer crushing means;
said second decomposer intermediate first impact blade assembly comprises a blade assembly radially mounted on an upper surface and on a lower surface of an intermediate assembly support mounted on said driving shaft of the second decomposer crushing means;
said second decomposer tangential lower blade assembly comprises a plurality of blades tangentially located on an upper surface of a support disc mounted on said driving shaft of the second decomposer crushing means; and
said second decomposer lower sweeper assembly comprises a plurality of sweepers radially located on a lower surface of said support disc mounted on said driving shaft of the second decomposer crushing means;
said driving shaft of the second decomposer crushing means being actuated by means of a set of pulleys, belts and gearmotors.

5. A waste processing plant according to claim 1, wherein said at least one second decomposer heating assembly comprises a plurality of resistors arranged on the outside of said second decomposer, said resistors being connected to respective thermocouples.

6. A waste processing plant according to claim 1, wherein said second decomposer is also equipped with at least a water injection arrangement that comprises at least a pipe which extends until a section of the same is arranged around said second decomposer in order to inject cold water inside the same, said pipe being connected to a cold-water storage tank through an injection pump.

7. A waste processing plant according to claim 1, wherein it is also equipped with at least a driven blade arrangement located at the upper portion of both said first decomposer and said second decomposer.

8. A waste processing plant according to claim 1, wherein said processed material storage hopper is provided with a processed material suction pump at an upper portion, ad a hopper discharge gate at a lower portion.

9. A waste processing plant according to claim 1, wherein each of said gas collection arrangements located on the upper portion of said first decomposer and second decomposer comprises:
at least a waste gas turbine operated by a corresponding turbine engine, and
a pair of gas discharge pipes having an upper end connected to said waste gas turbine and a lower end connected to a triangular section collector provided with a triangular collector turbine driven by means of a turbine gearmotor.

10. A waste processing plant according to claim 1, further comprising a conditioning chamber connected to said triangular section collector comprising a coating with an arrangement of electrical resistors, in turn said conditioning chamber being operatively connected to said gas storage tanks.

11. A waste processing plant according to claim 1, wherein at least one of said gas storage tanks is at ambient temperature, and each of said gas storage tanks comprises internally:
at least one lower perforated tee submerged in a volume of water,
at least a first filtering layer arranged immediately above the water volume and comprising a perforated sheet metal chamber provided with expanded polystyrene spheres immersed in lithium oil;
at least a second filtering layer arranged upstream of said first filtering layer, comprising solid carbon; and
at least a third filtering layer arranged upstream of said second filtering layer, comprising lithium oil together with polypropylene beads.

12. A waste processing plant according to claim 1, further comprising a second feed conveyor belt having a lower end and an upper end in communication with the second decomposer feed inlet, said second feed conveyor belt is driven by gear motors.

13. A method for processing waste using the waste processing plant according to claim 1, comprising the steps of:
a) discharging the waste into a pit below ground level and outside the plant;
b) operating the first feed conveyor belt so as to transport the waste from the pit to the first decomposer feed inlet;
c) operating the crushing means of the first decomposer so that the waste falling from the first decomposer feed inlet be impacted, cut and crushed by said first decomposer high-impact upper breaking assembly, first decomposer intermediate tangential blade assembly, and first decomposer lower sweeper assembly, until obtaining a partially processed residue that is dragged towards said second decomposer;
d) simultaneously with step c), operating the first decomposer waste gas turbine in order to extract the gases and/or vapors from the interior of the first decomposer and evacuate the same to the triangular section collector;
e) corroborating the state of the partially processed waste through a camera provided inside said first decomposer;
f) operating the first decomposer outlet gate so that the first decomposer lower sweeper assembly drags the partially processed residue into the second decomposer through the first decomposer outlet port;
g) operating the second decomposer crushing means so that the partial processed residue entering the second decomposer through the first decomposer outlet gate be further processed through said second decomposer high-impact upper breaking assembly, second decomposer intermediate first impact blade assembly, second decomposer tangential lower blade assembly, and second decomposer lower sweeper assembly, until obtaining a reduced processed final residue in powder form;
h) simultaneously with step g), operating the second decomposer heating assembly to a temperature set according to the volume of waste to be processed;
i) simultaneously with step g), operating the second decomposer waste gas turbine in order to extract the gases and/or vapors from the interior of the second decomposer and evacuate them to the triangular section collector;
j) operating the second decomposer discharge gate so that the final processed reduced residue be dragged to said processed material receiving module; and
k) operating the processed material suction pump so that the reduced processed final waste be transported for storage in said processed material storage hopper.

14. A method for processing waste according to claim 13, wherein simultaneously with step b), further comprises the step of: operating the second feed conveyor belt of the second decomposer in order to convey the waste from the pit to the second decomposer feed inlet.

15. A method for processing waste according to claim 13, wherein simultaneously with step h) water is injected through the water injection arrangement according to a temperature threshold detected by the thermocouples.

16. A method for processing waste according to claim 13, further comprising the step of operating the triangular collector turbine so that the gases coming from the first and second decomposer pass forcibly through said triangular section collector in order to produce the release of the liquids in suspension from the gases and/or vapors.

17. A method for processing waste according to claim 13, further comprising the step of operating the arrangement of electrical resistors of the conditioning chamber connected to said triangular section collector to raise the temperature of gases and/or vapors circulating and coming from the triangular section collector.

18. A waste decomposer comprising, at least, a crushing means wherein said crushing means comprises a high-impact upper breaking assembly, an intermediate tangential blade assembly, and a lower sweeper assembly, wherein:
said high-impact upper breaking assembly comprises a plurality of curved arms radially mounted at one end of a driving shaft crushing means;
said intermediate tangential blade assembly comprises a plurality of blades tangentially located on an upper surface of a support disc mounted on said driving shaft of the crushing means;
said first decomposer lower sweeper assembly comprises a plurality of sweepers radially located on a lower surface of said support disc mounted on said driving shaft of the crushing means;
said driving shaft of the first decomposer crushing means being actuated by means of a set of pulleys, belts and gearmotors.

19. The waste decomposer of claim 18, further comprising at least a heating assembly; wherein said heating assembly comprises a plurality of resistors arranged on the outside of said decomposer, said resistors being connected to respective thermocouples.

20. The waste decomposer of claim 18, further comprising at least a driven blade arrangement located on the upper portion of said decomposer.

21. The waste decomposer of claim 18, further comprising gas collection arrangements located on the upper portion of said decomposer; wherein said gas collection arrangements comprise:
at least a waste gas turbine operated by a corresponding turbine engine, and
a pair of gas discharge pipes having an upper end connected to said waste gas turbine and a lower end connected to means for treating said gases.

22. The waste decomposer of claim 21, wherein said gas treatment means comprises a triangular section collector provided with a triangular collector turbine driven by means of a turbine gearmotor and a conditioning chamber connected to said triangular section collector comprising a coating with an arrangement of electrical resistors, in turn said conditioning chamber being operatively connected to gas storage tanks.

23. The waste decomposer of claim 18, further comprising at least a water injection arrangement in order to inject cold water inside and control its temperature.
